(19) United States
(12) Patent Application Publication
(10) Pub. No.: US 2024/0240563 A1
(43) Pub. Date: Jul. 18, 2024

(54) DAMPER RING FOR REDUCING UNWANTED VIBRATIONS OF A BLISK, AS WELL AS BLISK AND TURBOMACHINE

(71) Applicant: MTU Aero Engines AG, Muenchen (DE)

(72) Inventors: Andreas HARTUNG, Munich (DE); Markus SCHLEMMER, Mainburg / Sandelzhausen (DE); Daniel THEURICH, Krreilling (DE); Adam KOSCSO, Munich (DE)

(21) Appl. No.: 18/618,367

(22) Filed: Mar. 27, 2024

(30) Foreign Application Priority Data
Mar. 28, 2023 (DE) 102023107888.7

(51) Int. Cl. F01D 5/10

(52) U.S. Cl. CPC F01D 5/10; F05D 2250/221; F05D 2250/241; F05D 2260/96

(57) ABSTRACT

A damper ring (1) for reducing unwanted vibrations of a blisk (2), which damper ring (1) is disposable at the radially inner side of a blade ring (3) of the blisk (2). The damper ring (1) features at least one damper element (4) configured to dissipate vibrational energy of the blisk (2) and/or to transfer vibrational modes of the blisk into vibrational modes different from the vibrational modes of the blisk. The invention also relates to a blisk (2) and to a turbomachine (13).

This claims the benefit of German Patent Application DE 102023107888.7, filed on Mar. 28, 2023 which is hereby incorporated by reference herein.

The invention relates to a damper ring for reducing unwanted vibrations of a blisk, which damper ring is disposable at the radially inner side of a blade ring of the blisk. The invention further relates to a blisk for a turbomachine, having a damper ring for reducing unwanted vibrations of the blisk, which damper ring is disposed at the radially inner side of a blade ring of the blisk, as well as to an associated turbomachine having at least one blisk.

### BACKGROUND

Integrally bladed turbomachine rotors (IBR) or blade integrated disks (BLISK) have rotor blades which are formed integrally with a main body, in one embodiment with a rotor disk, and which, in an embodiment, are formed in one piece with the rotor disk, in particular by primary shaping, or connected thereto by material-to-material bonding, preferably by welding, brazing, and/or adhesive bonding.

### SUMMARY OF THE INVENTION

When operated in a turbomachine, such rotors, especially their blades, may be subject to high thermo-mechanical loads. These include, inter alia, the vibrational stresses caused by external excitation and/or self-excitation. These unwanted vibrations can in particular affect the performance, especially the service life and robustness of the blisk. In some cases of particularly high vibrational loading, damping systems must be used to reduce these vibrations. For this purpose, there are known non-resonant damper rings as well as resonant damper rings (friction ring damper (FRD)) based on energy dissipation due to friction with the blisk, as well as based on absorption and energy transfer into other vibrational modes. However, these systems have proved to be inadequate in terms of their damper characteristics, so that the performance of the blisk is impaired.

It is an object of the present invention to provide a damper ring and a blisk having a damper ring whose performance is increased by improved vibration reduction.

One aspect of the invention provides a damper ring for reducing unwanted vibrations of a blisk. The damper ring is in particular disposable at or attachable to the radially inner side of a blade ring of the blisk. The damper ring has at least one damper element configured to dissipate vibrational energy of the blisk and/or to transfer vibrational modes of the blisk into vibrational modes different from the vibrational modes of the blisk. This makes it possible to achieve a particularly effective reduction of vibrations.

The damper ring is in particular annular in shape. In particular, a radially outer contour or a radially outer surface of the damper ring may be smooth and circular. The outer surface of the damper ring may in particular be disposed against and in contact with a complementarily shaped radially inner side of the blade ring of the blisk, in particular in such a way that these surfaces can be at least form-fittingly disposed against one another. In an embodiment, this makes it possible to advantageously use space available radially inwardly of the rotor blades and/or to improve the reduction of vibrations.

The blade ring, also referred to as inner shroud, is provided on its radially outer side with the blades of the blisk, which are integrally connected to the blade ring. Preferably, the blades are uniformly distributed in a circumferential direction of the blade ring on the outside thereof.

The at least one damper element of the damper ring is in particular designed and adapted to be able to dissipate the vibrational energy of the blisk and/or to transfer vibrational modes of the blisk into vibrational modes different from the vibrational modes of the blisk. In other words, the damper element can absorb at least a portion of the vibrational energy of the blisk and convert it to other forms of energy and/or energy localizations. Other forms of energy may include, in particular, heat and/or vibrational energy having vibrational modes different from the vibrational modes of the blisk. Other forms of energy are conceivable. “Other vibrational modes” can, in particular, be understood to be those which are less critical than a critical vibration in the resonant range of the blisk, caused, in particular, by external excitation and/or self-excitation. This is a particularly advantageous way of enhancing a vibration reduction of the blisk and thus an improvement of the blisk. In this connection, it has been found to be particularly effective if the damper ring has the at least one damper element that dissipates the vibrational energy.

As is customary in the art, the term “axial” as used herein refers in particular to a direction parallel to a (main) machine axis or axis of rotation of the turbomachine or of the blisk or of the damper ring, the term “circumferential direction” refers to a direction of rotation about this axis, and the term “radial” refers to a direction that is perpendicular to the axial and circumferential directions, in particular away from the axis.

One embodiment provides that a natural frequency of the damper element substantially corresponds to a natural frequency of the blisk. In other words, the damper element is a damper element that is resonant with the blisk. “Substantially” is to be understood to mean that the natural frequency may deviate by up to 1%, up to 2%, or up to 3% from a natural frequency of the blisk. The damper element may be specifically designed for an associated blisk to be damped, especially a series of blisks. In a series of blisks, the respective natural frequencies may differ from each other, so that it may be provided that the natural frequency of the damper element may substantially correspond to a mean value of the natural frequencies of the series of blisks. Resonant damping is advantageous because at a frequency at which the blisk may vibrate with increasing amplitude and at which high vibration loads occur, these vibrations can be reduced in a targeted manner at this frequency, especially as compared to damper rings of blisks with no or less movement. Thus, vibration damping by means of the resonant damper element is particularly effective.

One embodiment provides that the damper ring has an outer ring, which is disposable at the radially inner side of the blade ring. In particular, the outer ring includes the outer surface of the damper ring, which outer surface can be connected to the inner side of the blade ring.

Preferably, the damper ring has an inner ring. The outer ring and the inner ring may preferably be configured coaxially or concentrically with each other. In particular, a diameter of the inner ring is smaller than a diameter of the outer ring. In other words, the inner ring is radially within the outer ring.

Preferably, the outer ring and the inner ring of the damper ring are connected to each other by radially extending web elements. The web elements or struts may in particular be thin-walled and may extend substantially in the radial direction and in the axial direction in accordance with an axial depth of the damper ring. The web elements extend in particular perpendicularly away from the inner ring and from the outer ring. The web elements, the inner ring, and the outer ring may for example, be formed integrally with one another. It may also be conceivable that the web elements are joined to the inner ring and the outer ring or connected to one another in an alternative way.

The damper ring has at least two web elements, which may be offset by 180° in the circumferential direction. In particular, the damper ring has a plurality of any number of web elements, which may be uniformly spaced apart in the circumferential direction. Preferably, a damper element may be disposed between each two web elements or a web element may be disposed between each two damper elements. In particular, the web elements and the damper elements are spaced apart, i.e., are not disposed in contact with each other.

Preferably, the damper ring forms an intermediate space between the inner ring and the outer ring. The damper element may preferably be formed within the intermediate space. The intermediate space may in particular be divided into compartments separated from each other by the web elements. A compartment may have disposed therein one damper element, two damper elements, or a plurality of damper elements. In addition, it may be provided that no damper element is disposed in certain compartments.

This design of the damper ring makes it possible to achieve a particularly effective reduction of vibrations. A further advantage may be that the damper elements may be pre-mountable on the damper ring, and that the pre-assembled damper ring can finally be connected to the blisk. This facilitates in particular an assembly method.

One embodiment provides that the at least one damper element is connected to the inner ring via a radially extending pin element. The respective pin element may in particular be thin-walled and may extend substantially in the radial direction and in the axial direction in accordance with the axial depth of the inner ring. The pin elements extend in particular perpendicularly away from the inner ring. In particular, each damper element is connected to the inner ring via an associated pin element. The pin element may in particular be formed integrally with the inner ring or joined thereto, preferably by welding, or otherwise connected thereto. In particular, the inner ring is connected to a radially inner end of the pin element.

The damper element is in particular connected to a radially outer end of the pin element and may in particular be joined, preferably welded, screwed, or the like, to the pin element or to the radially outer end. The pin element and the damper element may preferably be welded together.

Such disposition of the damper element can lead to a particularly advantageous vibration damping of the blisk. In particular, the vibrations of the blisk can be transferred particularly effectively via the outer ring to the inner ring via the pin element and the damper element, which absorbs and effectively dissipates the vibration energy and/or to transfer vibrational modes of the blisk into different vibrational modes which are less critical for the blisk.

One embodiment provides that the at least one damper element is cuboid-shaped or box-shaped. The damper element and the pin element together may in particular, be T-shaped in cross section, and the damper element may preferably be disposed centrally on the pin element. In this embodiment, the damper element extends with its width substantially perpendicular to the radial and axial directions and has a certain thickness in the radial direction and a certain depth in the axial direction, which are in particular smaller than the width of the damper element. Such a shape has proven to be particularly effective for vibration damping.

An alternative embodiment provides that the damper element is configured to be spherical in shape, for example as a hollow sphere or a solid sphere. It may be provided that a first damper element of the damper ring is cuboid-shaped and a second damper element is spherical in shape. In addition, the damper element may have any other suitable shape, especially in any combination.

One embodiment provides that the damper element has a housing having at least one cavity in which at least one impulse element is accommodated with play. The impulse element is in particular designed to collide with inner walls of the respective cavity when the blisk is in an excited vibrational state. The vibration energy can advantageously be dissipated by the impacts. In other words, this allows energy to be transferred by means of the impacts, thereby reducing the vibrational energy. In this connection, one may also speak of what is known as “impulse mistuning.” In this embodiment, the damper element may be a so-called “impulse mistuner”, such as disclosed, for example, in DE 10 2016 204 281 A1. The impulse mistuner may in particular have a plurality, for example, 2, 4, 6, or 8 cavities in each of which an impulse element may be accommodated with play. The impulse element may for example, be spherical, and the cavities may for example, be cuboid-shaped. A damper element of this type, which is in particular also resonant, allows the vibrations to be reduced in a particularly advantageous and effective manner.

One embodiment provides that the housing of the damper element is spaced apart from the outer ring. In particular, a gap is provided between the housing and the radially inner side of the outer ring, both in the state of rest and in the rotating state of the damper ring. In an embodiment, this makes it possible to achieve a particularly effective reduction of vibrations.

One embodiment provides that the damper element is frictionally connected to the outer ring. This embodiment is particularly suitable when the damper element is not configured as an impulse mistuner, but, for example, is spherical in shape. In this context, “frictionally” means that at least in a rotating state of the damper ring, the damper element contacts the outer ring, whereby friction is caused by relative motion with respect to each other. In particular, the vibrations can thus be reduced particularly effectively in that the damper element absorbs the vibrational energy, possibly converts it into vibrational energy with a frequency different from the natural frequency of the blisk, and reduces it by friction with the outer ring caused by the vibration and/or transfers vibrational modes of the blisk into different vibrational modes which are less critical for the blisk. In other words, in this embodiment, the damper element is a friction-based absorber.

One embodiment provides that the damper element is formed in the circumferential direction of the damper ring within a sector of the damper ring, the sector in particular having a central angle of 3°, 5°, or 10°, or selected from the range of 2°to 15°. In other words, the extent of the damper element in the circumferential direction is limited to a segment of the damper ring. Thus, in particular, the damper ring does not itself correspond to the damper element.

One embodiment provides that the damper ring has a plurality of damper elements. In particular, a plurality of damper elements can significantly improve the vibration reduction. The damper elements may in particular be uniformly distributed in the circumferential direction. The number of damper elements may be dependent on or independent of a diameter of the damper ring or a number of rotor blades of the blisk provided.

The invention also includes the combinations of the features of the described embodiments.

A further aspect of the invention provides a blisk for a turbomachine. The blisk in particular has a damper ring for reducing unwanted vibrations of a blisk, which damper ring is disposed at the radially inner side of a blade ring (inner shroud) of the blisk. The damper ring has at least one damper element configured to dissipate vibrational energy of the blisk and/or to transfer vibrational modes of the blisk into different vibrational modes which are less critical for the blisk. In an embodiment, this makes it possible to advantageously use space available radially inwardly of the rotor blades and/or to improve the reduction of vibrations.

The blisk may in particular be designed as a turbine blisk or a compressor blisk of a gas turbine.

In particular, the damper ring of the blisk may be configured according to any of the embodiments described herein.

One embodiment of the blisk provides that the damper ring and the blade ring are connected to each other by a shrink-fit connection. In other words, the blade ring is shrunk onto the damper ring, for example, by cooling the damper ring and heating the blisk prior to assembly. After thermal equalization, the damper ring and the blade ring are thus preferably form-fittingly and force-fittingly connected to each other.

Alternatively, the damper ring and the blisk may also be connected to each other in another way.

One embodiment of the blisk provides that the damper ring has a plurality of damper elements, a number of blades corresponding to the plurality of a number of damper elements or a multiple of the number of damper elements. At least the number of damper elements may be dependent on the number of blades. Preferably, each blade, or each second, third or fourth blade, or specifically selected blades is/are each associated with a damper element. For example, the damper element is disposed radially inwardly of an outlet edge or an inlet edge of the blade, or in the middle of the blade, or between two adjacent blades.

In an embodiment, the, or one or more, cavity/cavities of the, or of one or more of the, impulse element housing(s) is/are (each) spaced in the circumferential direction from a leading edge or a trailing edge of a (circumferentially) nearest blade of the rotor by no more than 25%, in particular no more than 15%, in one embodiment no more than 10% of a blade pitch. In an embodiment, the blade pitch is a distance between adjacent leading or trailing edges in the circumferential direction, as is customary in the art. In an embodiment, this arrangement of cavities as directly as possible under the leading or trailing edge of one or more rotor blades makes it possible to achieve a particularly effective reduction of vibrations.

A further aspect of the invention provides a turbomachine, in particular a gas turbine, preferably an aircraft gas turbine. The turbomachine includes at least one blisk according to the invention.

### BRIEF DESCRIPTION OF THE DRAWINGS

Other advantageous embodiments of the present invention will become apparent from the dependent claims and the following description of preferred embodiments. To this end, the drawings show, partly in schematic form, in:

FIG. 1 an axial view of a portion of an inventive blisk according to a preferred embodiment;

FIG. 2 a perspective transparent view of a damper element according to a preferred embodiment; and

FIG. 3 a schematic view of a damper element according to an alternative embodiment.

### DETAILED DESCRIPTION

The exemplary embodiment described below is a preferred embodiment of the invention. In the exemplary embodiment, the described components of the embodiment each represent individual features of the invention which are to be considered independently of each other and which each refine the invention also independently of each other and therefore should be considered to be part of the invention, either individually or in a combination other than the one shown. Furthermore, the embodiment described may also be supplemented by further features of the invention that have already been described. In the figures, functionally equivalent elements are denoted by the same reference numerals.

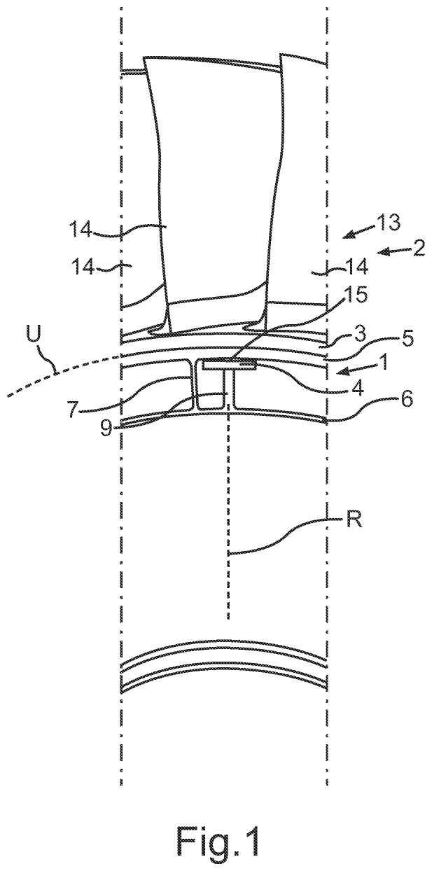

FIG. 1 shows a portion of an inventive blisk 2 for a turbomachine 13 in an axial view according to a preferred embodiment. Blisk 2 may have a blade ring 3, which is provided on its radially outer side with blades 14 distributed in circumferential direction U. A damper ring 1 for reducing unwanted vibrations of blisk 2 maybe disposed at the radially inner side of blade ring 2.

In particular, damper ring 1 and blade ring 3 maybe formed separately and connected together by a shrink-fit connection. Blade ring 3 may in particular have a free space at its radially inner side around the entire circumference thereof, in which free space damper ring 1 can be disposed.

Damper ring 1 may have an outer ring 5 and an inner ring 6, which may be connected to each other by radially extending web elements 7. Outer ring 5 maybe disposable or disposed with its outer side at and radially inwardly of an inner side of blade ring 3 in a form-fitting and/or force-fitting manner. In an exemplary embodiment, the damper ring may have at least one damper element 4 configured to dissipate vibrational energy of blisk 2 and/or to transfer vibrational modes of the blisk into different vibrational modes which are less critical for the blisk, which damper element 4 maybe formed within an intermediate space 8 between inner ring 6 and outer ring 5. Damper element 4 may for example, be connected to inner ring 6 via a radially extending pin element 9 to inner ring 6, and, in this connection, a radially inner end of pin element 9 maybe connected to inner ring 6 and a radially outer end of the pin element 9 to damper element 4. In particular, damper element 4 is centrally connected to pin element 9, so that damper element 4 and pin element 9 together may be arranged substantially in the shape of a T.

Damper element 4 may in particular be configured to be resonant with blisk 2. This means that damper element 4 and blisk 2 have substantially the same natural frequency.

In the exemplary embodiment shown, a gap 15 is provided between damper element 4 and outer ring 5, so that damper element 4 and outer ring 5 do not touch each other; i.e., are spaced apart. Damper element 4 may also be spaced apart from web element 7. Preferably, damper element 4 is only connected to pin element 9.

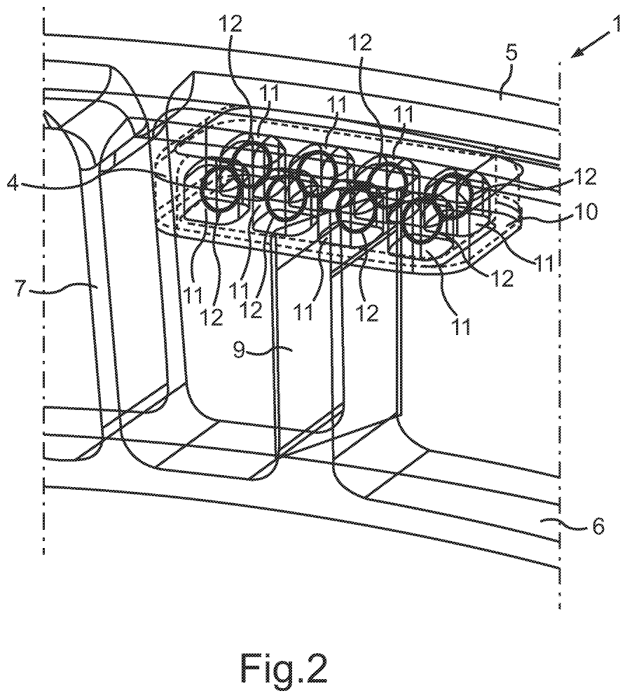

In the exemplary embodiment shown, damper element 4 is cuboid-shaped and extends substantially perpendicular to radial direction R and to the axial direction. In an exemplary embodiment, damper element 4 maybe formed as a so-called “impulse mistuner” 4, shown in more detail in FIG. 2.

FIG. 2 shows a perspective transparent view of the damper element 4 according to a preferred embodiment, in particular as an impulse mistuner 4. Impulse mistuner 4 may for example, have a housing 10, which may have at least one cavity 11 herein, here eight separate cavities 11 . Each of the cavities 11 may have an impulse element 12 accommodated with play therein, so that the impulse elements 12 (e.g., spheres) can move freely. The vibrational energy may in particular be reduced by impacts; i.e., by impulse mistuning.

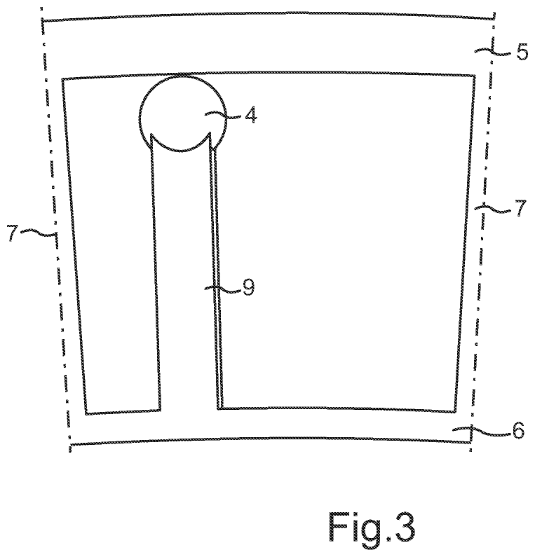

FIG. 3 shows a schematic view a of a damper element 4 according to an alternative, in particular spherical embodiment. However, damper element 4 may also be of any other advantageous shape. The spherical damper element 4 may in particular be frictionally connected to the inner side of outer ring 5 of damper ring 1, so that the vibrational energy of blisk 2 can be dissipated due to the friction. In the example shown, damper element 4, which is connected via the pin element 9 to inner ring 6, may be located closer to an adjacent left web element 7 than to an adjacent right web element 7. However, damper element 4 is not limited to the shown position with respect to web elements 7. In particular, the damper element can be arranged centrally between two web elements 7.

Overall, the examples show how a damping system can be provided for blisks 2. For this purpose, a resonant damper ring 2 is modified, in particular by the formation of outer ring 5 and inner ring 6 as well as, in that an impulse mistuner is used as a mechanism of a resonant damper element 4. Parameters of the components of damper ring 1 and of blisk 2 may vary from the examples shown, in particular masses, thicknesses, dimensions, stiffnesses, distances, etc. Likewise, possible positions, in particular of damper elements 4, may vary, for example under the outlet edge or inlet edge of a blade 14, centrally under the blade 14, or between two blades 14. Also possible are positions under every second or under every third or under selected individual blades 14.

### LIST OF REFERENCE NUMERALS

1 damper ring
2 blisk
3 blade ring
4 damper element
5 outer ring
6 inner ring
7 web element
8 intermediate space
9 pin element
10 housing of the damper element
11 cavity of the damper element
12 impulse element of the damper element
13 turbomachine
14 blades
15 gap

What is claimed is:

1. A damper ring for reducing unwanted vibrations of a blisk, the damper ring being disposable at the radially inner side of a blade ring of the blisk, the damper ring comprising:
at least one damper element configured to dissipate vibrational energy of the blisk or to transfer vibrational modes of the blisk into vibrational modes different from the vibrational modes of the blisk.

2. The damper ring as recited in claim 1 wherein a natural frequency of the damper element corresponds to a natural frequency of the blisk.

3. The damper ring as recited in claim 1 further comprising an outer ring disposable at the radially inner side of the blade ring and an inner ring connectable to the outer ring by radially extending web elements, the damper element being formed within an intermediate space between the inner ring and the outer ring.

4. The damper ring as recited in claim 3 wherein the damper element is connected to the inner ring via a radially extending pin element.

5. The damper ring as recited in claim 1 wherein damper element is cuboid-shaped.

6. The damper ring as recited in claim 1 wherein the damper element is spherical in shape.

7. The damper ring as recited in claim 1 wherein the damper element has a housing having at least one cavity, at least one impulse element being accommodated with play in the cavity.

8. The damper ring as recited in claim 7 wherein the housing is spaced apart from the outer ring and wherein a natural frequency of the damper element corresponds to a natural frequency of the blisk.

9. The damper ring as recited in claim 1 wherein the damper element is frictionally connected to the outer ring.

10. The damper ring as recited in claim 1 wherein the damper element is formed in a circumferential direction within a sector of the damper ring, the sector having a central angle of 3°, 5°, or 10°.

11. The damper ring as recited in claim 1 wherein the at least one damper element includes a plurality of damper elements.

12. A blisk for a turbomachine, the blisk comprising:
a blade ring having a radially inner side;
a damper ring for reducing unwanted vibrations of the blisk and disposed at the radially inner side, the damper ring having at least one damper element configured to dissipate vibrational energy of the blisk or to transfer vibrational modes of the blisk into vibrational modes different from the vibrational modes of the blisk.

13. The blisk as recited in claim 12 wherein the damper ring and the blade ring are connected to each other by a shrink-fit connection.

14. The blisk as recited in claim 12 wherein at least one damper element includes a plurality of damper elements, a number of blades of the blisk corresponding to a number of damper elements or a multiple of the number of damper elements.

15. A turbomachine comprising at least one blisk as recited in claim 12.

16. A gas turbine comprising the turbomachine as recited in claim 15.
